(19) United States
(12) Patent Application Publication
(10) Pub. No.: US 2007/0050792 A1
(43) Pub. Date: Mar. 1, 2007

(54) Optical recording and playback apparatus to open and close a safety door

(76) Inventor: Sang Jin Bae, Suwon-Si (KR)

Correspondence Address: STANZIONE & KIM, LLP, 919 18TH STREET, N.W., SUITE 440, WASHINGTON, DC, 20006, US

(21) Appl. No.: 11/353,125

(22) Filed: Feb. 14, 2006

(30) Foreign Application Priority Data
Aug. 29, 2005 (KR) 2005-79350

(51) Int. Cl. G11B 33/02

(52) U.S. Cl. 720/647

(57) ABSTRACT

An optical recording and playback apparatus prevents a disc from being ejected from the optical recording and playback apparatus during operation of the optical recording and playback apparatus. The optical recording and playback apparatus includes a main body having an entrance, a deck mounted in the main body and having a spindle motor and an optical pickup unit, a tray mounted at the main body such that the tray is inserted into or ejected from the main body through the entrance, a loading unit to insert or eject the tray into or from the main body, a safety door mounted at the entrance, and a door opening and closing unit to move forward and backward according to an operation of the loading unit to open and close the safety door.

### CROSS-REFERENCE TO RELATED APPLICATIONS

This application claims the benefit under 35 U.S.C. § 119 of Korean Patent Application No. 2005-79350, filed on Aug. 29, 2005 in the Korean Intellectual Property Office, the disclosure of which is incorporated herein in its entirety by reference.

### BACKGROUND OF THE INVENTION

1. Field of the Invention

The present general inventive concept relates to an optical recording and playback apparatus, and more particularly, to an optical recording and playback apparatus including a safety door to prevent a disc from being ejected during operation from the optical recording and playback apparatus.

2. Description of the Related Art

An optical recording and playback apparatus is an apparatus that is capable of reading information (e.g., audio, video, and data) from a disc and recording the information to the disc. The optical recording and playback apparatus is generally used in computers or digital electric home appliances. A conventional optical recording and playback apparatus is disclosed in Korean Unexamined Patent Publication No. 10-2004-0082214.

The conventional optical recording and playback apparatus includes a tray to insert a recording medium (i.e., the disc) into a main body such that the disc is located on a drive unit. At an upper surface of the tray is disposed a disc location part, on which the disc is located. The tray is slidably inserted into or ejected from the main body through an entrance formed at a front surface of the main body while the disc is located on the tray. When information is read from the disc or information is recorded on the disc after the disc is inserted into the main body, the disc is rotated at a high speed by the drive unit.

When an external impact is applied to the optical recording and playback apparatus during an operation of the optical recording and playback apparatus, the disc, which is rotated at the high speed, may be separated from the drive unit and then ejected from the optical recording and playback apparatus through a gap between the entrance of the main body and the tray, and users may be injured. Recently developed optical recording and playback apparatuses can perform a 52× speed recording operation, in which a disc is rotated at 10,000 rpm or faster. Consequently, a possibility of injury is further increased. Therefore, computers or electric home appliances including the optical recording and playback apparatus have a front door mounted in front of the entrance of the optical recording and playback apparatus to prevent the disc from being ejected from the optical recording and playback apparatus.

However, conventionally, the front door is configured so that the front door is pushed by the tray and thus opened when the tray of the optical recording and playback apparatus is ejected from the optical recording and playback apparatus, and the front door is closed by an elastic force of a spring when the tray is inserted into the optical recording and playback apparatus. Consequently, a user can easily open the front door from the outside of the front door, and therefore, a possibility of injury is not completely eliminated.

### SUMMARY OF THE INVENTION

The present general inventive concept provides an optical recording and playback apparatus constructed such that a disc is prevented from being ejected during operation from the optical recording and playback apparatus.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing an optical recording and playback apparatus comprising a main body having an entrance, a deck mounted inside the main body and having a spindle motor and an optical pickup unit, a tray to be inserted into or ejected from the main body through the entrance, a loading unit to insert or eject the tray into or from the main body, a safety door mounted at the entrance, and a door opening and closing unit to move forward and backward according to an operation of the loading unit to open and close the safety door.

The tray may have a first rack gear extending a predetermined length in a main direction in which the tray is inserted or ejected, and the loading unit may include a loading motor, a pinion gear engaged with the first rack gear to be rotated by the loading motor, and first cam having a second rack gear engaged with the pinion gear, the first cam being moved forward and backward according to an operation of the pinion gear to raise and lower the deck.

The safety door may be mounted at the entrance of the main body such that the safety door is moved upward and downward.

The door opening and closing unit may include a second cam disposed behind the safety door such that the second cam is moved forward and downward in a lateral direction, the second cam having at least one inclined slot, by which the door opening and closing unit is coupled with the safety door, at least one guide protrusion extending from the safety door such that the at least one guide protrusion is inserted into the at least one inclined slot, and a connection member connected between the second cam and the first cam.

The first cam, the second cam, and the connection member may be integrally formed.

The foregoing and/or other aspects of the present general inventive concept may be achieved by providing optical recording and playback apparatus including a main body having an entrance, a deck movably mounted inside the main body and having at least one of a spindle motor and an optical pickup unit, a tray to move through the entrance, a safety door movably mounted at the entrance, and a loading unit to move the deck, the tray, and the safety door

The foregoing and/or other aspects of the present general inventive concept may also be achieved by providing an inserting and removing disc system usable with an optical recording and playback apparatus, including a loading unit to insert or eject a disc into or from the optical recording and playback apparatus through an entrance, a deck to move the inserted disc between a first level at which the disc is inserted in optical recording and playback apparatus to a second level during an operation of the optical recording and playback apparatus, and a safety door unit to open and close the entrance according to an operation of the loading unit.

The foregoing and/or other aspects of the present general inventive concept may also be achieved by providing an optical recording and playback apparatus including a main body having an entrance, a loading unit to insert or eject a recording medium into or from the main body through the entrance, a door opening and closing unit to move forward and backward according to an operation of the loading unit, to open and close the entrance; and a disc securing mechanism to raise the recording medium at a level above the entrance level coupled to the door opening and closing unit closing the entrance.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a plan view illustrating an optical recording and playback apparatus according to the present general inventive concept;

FIG. 2 is a perspective view illustrating the structure of the optical recording and playback apparatus of FIG. 1 when a safety door is opened;

FIG. 3 is a perspective view illustrating the structure of the optical recording and playback apparatus of FIG. 1 when the safety door is closed; and

FIG. 4 is an exploded perspective view illustrating a safety door and first and second cams of the optical recording and playback apparatus of FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

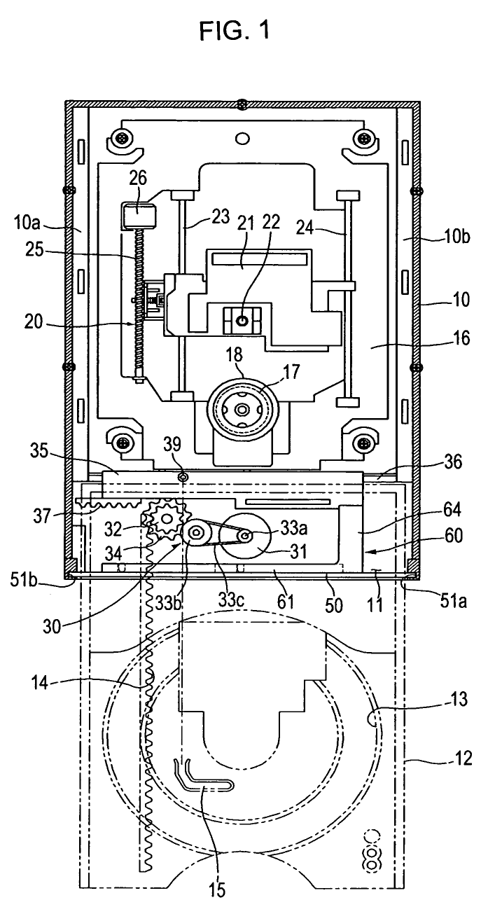

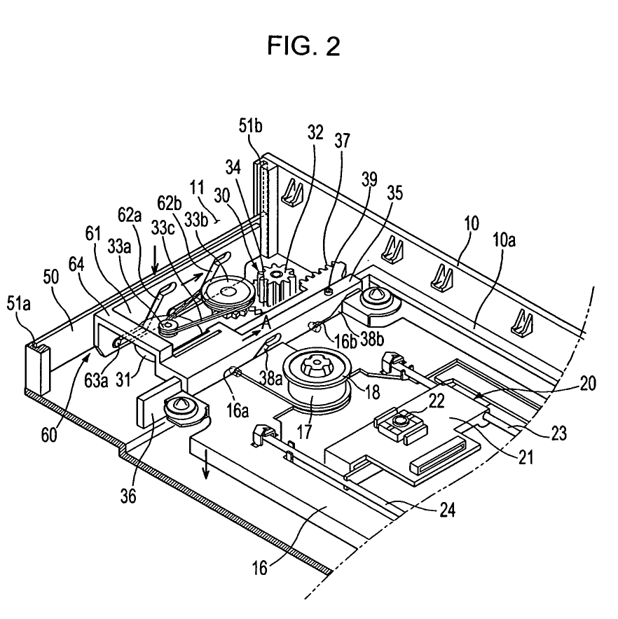

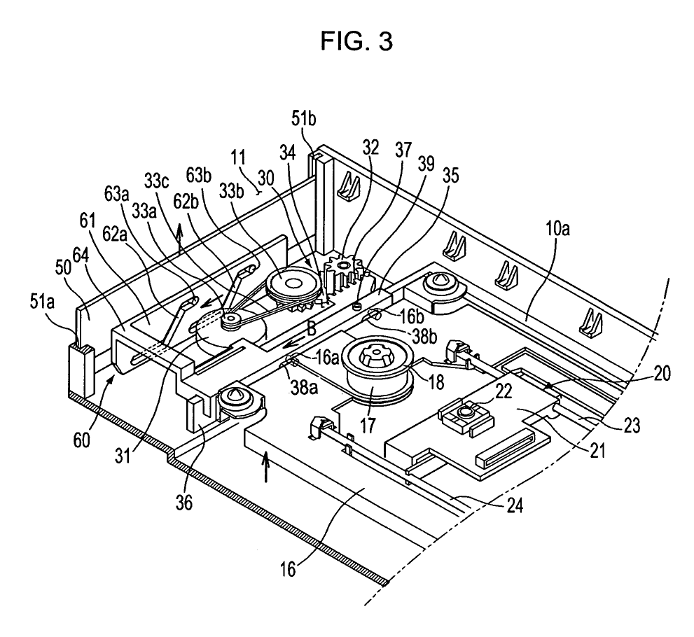

FIG. 1 is a plan view illustrating an optical recording and playback apparatus according to an embodiment of the present general inventive concept, FIG. 2 is a perspective view illustrating the optical recording and playback apparatus of FIG. 1, when a safety door is opened, and FIG. 3 is a perspective view illustrating the structure of the optical recording and playback apparatus of FIG. 1 when the safety door is closed. Referring to FIGS. 1 and 2, the optical recording and playback apparatus includes a main body 10 having an entrance 11 formed at a front surface thereof and a tray 12 configured such that the tray 12 can be inserted into or ejected from the main body 10 through the entrance 11 of the main body 10. The optical recording and playback apparatus further includes a loading unit 30 to insert or eject the tray 12 into or from the main body 10, a deck 16 mounted in the main body 10 such that the deck 16 can be moved upward and downward, a spindle motor 17 and an optical pickup unit 20 mounted on the deck 16, and a safety door 50 to close the entrance 11 after the tray 12 is inserted into the main body 10.

The tray 12 has a disc location part 13 formed at an upper surface thereof such that a recording medium (such as a disc) is located on the disc location part 13. For convenience of the following description, the recording medium is referred to as the disc, but is should be understood that the present general inventive concept is not intended to be limited to the disc as the recording medium. Opposite ends of the tray 12 are supported by main body guide rails 10a and 10b mounted in the main body 10 at opposite sides of the main body 10 such that the tray 12 can be slidably inserted into or ejected from the main body 10. At a lower surface of the tray 12 is disposed a first rack gear 14, which extends a predetermined length in a main direction in which the tray 12 is inserted or ejected such that the tray 12 is inserted or ejected.

The deck 16 is configured as a flat board and is moved upward and downward by the loading unit 30, which will be described below. The spindle motor 17 is mounted on an upper surface of the deck 16 to rotate the disc inserted into or loaded on the tray 12. A turntable 18 is fixed to a shaft of the spindle motor 17 where a center of the disc is located. Consequently, when the deck 16 is moved upward by the operation of the loading unit 30 after an insertion (or loading) of the disc into the tray 12 is completed, the disc is located on the turntable 18 of the spindle motor 17.

The optical pickup unit 20 includes a support plate 21 configured to be moved forward or backward in a radial direction of the turntable 18 (i.e., a radial direction of the disc), an optical pickup 22 mounted on the support plate 21 to read information from the disc or record information to the disc, support guide rails 23 and 24 mounted at the deck 16 to support the support plate 21 such that the support plate 21 can be moved forward or backward, a transferring screw 25 to transfer the support plate 21, and a transferring motor to rotate the transferring screw 25. Consequently, the optical pickup 22 mounted on the support plate 21 is moved forward and backward in the radial direction of the disc to read information from the disc or record information to the disc.

The loading unit 30 includes a loading motor 31 and a pinion gear 32 configured to be rotated by the loading motor 31. The pinion gear 32 is connected to the loading motor 31 such that the pinion gear 32 can be decelerated by pulleys 33a and 33b, a connection belt 33c, and an intermediate gear 34. Also, the pinion gear 32 is engaged with a first rack gear 14, which is disposed at the lower surface of the tray 12. Consequently, when the loading motor 31 is rotated, the pinion gear 32 is rotated, so that the tray 12 is inserted into or ejected from the main body 10.

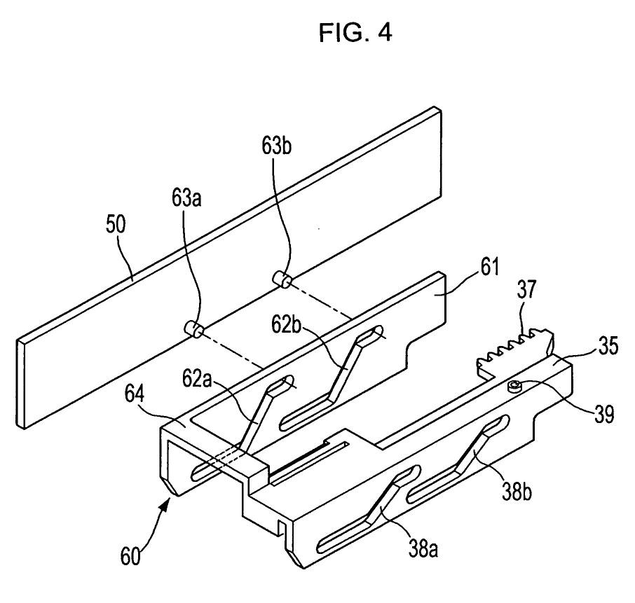

The loading unit 30 further includes a first cam 35 to raise and lower the deck 16, at which the spindle motor 17 and the optical pickup unit 20 are mounted. As illustrated in FIGS. 1 and 2, the first cam 35 is mounted in the main body 10 such that the first cam 35 can be moved forward and backward in a lateral direction intersecting the main direction in which the tray 12 is inserted or ejected. The first cam 35 is supported by a rail 36 disposed at a bottom surface of the main body 10 such that the first cam 35 can be moved forward and backward. At one side of the first cam 35 is disposed a second rack gear 37, which is engaged with the pinion gear 32 after the tray 12 is inserted. As illustrated in FIGS. 2 and 4, the first cam 35 further includes inclined slots 38a and 38b, through which the deck 16 is moved upward and downward when the first cam 35 is moved forward and backward in the lateral direction. Into the slots 38a and 38b are inserted guide protrusions 16a and 16b, respectively, which are protruded from the deck 16. Consequently, when the first cam 35 is moved forward and backward according to the operation of the pinion gear 32, the deck 16 is moved upward and downward, so that the spindle motor 17 and the optical pickup unit 20 are also moved upward and downward.

As illustrated in FIGS. 1 and 2, the second rack gear 37 of the first cam 35 is not engaged with the pinion gear 32 when the tray 12 is ejected from the main body 10. When the tray 12 is inserted into the main body 10, however, the first cam 35 is moved a predetermined distance in the lateral direction while a cam guide protrusion 39 formed at an upper end of the first cam 35 is guided along a cam guide groove 15 formed at the lower surface of the tray 12. As a result, the second rack gear 37 is engaged with the pinion gear 32. When the second rack gear 37 is engaged with the pinion gear 32, the insertion of the tray 12 has already been completed, and therefore, the first rack gear 14 is disengaged from the pinion gear 32. At this time, the tray 12 is not moved, and, as illustrated in FIG. 3, the first cam 35 is moved in a direction indicated by an arrow B to raise the deck 16. Consequently, the disc is located on the turntable 18 of the spindle motor 17. The cam guide groove 15 includes a first groove formed in the main direction to receive the cam guide protrusion 39, a second groove formed to have an angle with the main direction to insert the cam guide protrusion 39, the second groove being formed to have an angle with the main direction to move the cam guide protrusion 39 and the first cam 35 so that the pinion gear 32 is engaged with the second rack gear 37 during moving of the tray 12 from an unloading position to a loading position in the main direction, and a third groove formed in the lateral direction to guide a movement of the cam guide protrusion 39 and the first cam 35 in the lateral direction after the tray is in the loading position.

When the disc is separated from the turntable 18 of the spindle motor 17, the loading motor 31 is rotated in the reverse direction, and the above-described process is performed in reverse order. Specifically, as illustrated in FIG. 2, the first cam 35 is moved in a direction indicated by an arrow A. As a result, the deck 16 is moved downward, and therefore, the disc is separated from the turntable 18 of the spindle motor 17. Subsequently, the first rack gear 14 of the tray 12 is engaged with the pinion gear 32, and therefore, the tray 12 is ejected from the main body 10.

Opposite ends of the safety door 50 are fitted in safety door guide rails 51a and 51b disposed on opposite sides of the entrance 11 of the main body 10, respectively, such that the safety door 50 is moved upward and downward a predetermined distance to open and close the entrance 11 of the main body 10. Behind the safety door 50, a door opening and closing unit 60 is mounted to close the safety door when the tray 12 is inserted into the main body 10 according to the operation of the loading unit 30 and to open the safety door 50 when the tray 12 is ejected from the main body 10 according to the operation of the loading unit 30.

As illustrated in FIGS. 2 and 4, a door opening and closing unit 60 includes a second cam 61 disposed behind the safety door 50 to enable the second cam 61 to be moved forward and backward in the lateral direction, inclined slots 62a and 62b of the second cam 61, by which the door opening and closing unit 60 is coupled with the safety door 50, safety door guide protrusions 63a and 63b extending from a rear surface of the safety door 50 to allow the safety door guide protrusions 63a and 63b to be inserted into the inclined slots 62a and 62b, respectively, and a connection member 64 to connect the second cam 61 and the first cam 35 of the loading unit 30. Consequently, when the first cam 35 is moved forward and backward in the lateral direction according to an operation of the loading unit 30, the second cam 61, which is connected to the first cam 35 via the connection member 64, is moved forward and backward in the lateral direction to open and close the safety door 50. The first cam 35, the second cam 61, and the connection member 64 may be integrally manufactured by injection molding of a resin material. However it should be understood that the present general inventive concept is not intended to be limited by the first cam 35, the second cam 61, and the connection member 64 being integrally manufactured. The first cam 35 and the second cam 61 may include additional slots extended in the lateral direction from both ends of the inclined slots 62a, 62b, 38a and 38b, the pinion gear 32 may be disposed on the second cam 61 to move the second cam 61 and the first cam 35 according to an operation of the loading unit. In this case, the cam guide protrusion 39 may be formed on the second cam 61, and the cam guide 15 may be formed to correspond to the cam guide protrusion 39.

Opening and closing operations of the safety door 50 of the optical recording and playback apparatus will now be described with reference to FIGS. 1-3.

As illustrated in FIG. 3, the tray 12, on which the disc is located, is completely inserted into the main body 10, and then the first cam 35 is moved in the lateral direction as indicated by the arrow B to raise the deck 16. At the same time, the second cam 61, which is connected to the first cam 35, is moved in the lateral direction as indicated by the arrow B to raise the safety door 50. Specifically, when the second cam 61 is moved in the lateral direction as indicated by the arrow B, the guide protrusions 63a and 63b extending from the safety door 50 are guided upward along the inclined slots 62a and 62b of the second cam 61, respectively. As a result, the safety door 50 is raised, and therefore, the entrance of the main body 10 is closed. Consequently, even when the disc is separated from the turntable 18 due to an external impact occurring during an operation of the optical recording and playback apparatus, the disc is prevented from being ejected from the main body 10 through the entrance 11, and therefore, safe use of the optical recording and playback apparatus is accomplished.

When the operation of the optical recording and playback apparatus is completed, and the disc is separated from the turntable 18, as illustrated in FIG. 2, the first cam 35 is moved in the lateral direction indicated by the arrow A, and the second cam 61, which is connected to the first cam 35, is also moved in the direction indicated by the arrow A. Consequently, the safety door 50 is lowered to open the entrance 11, and therefore, the tray 12 is ejected from the main body 10.

As described above, the safety door 50 is raised, when the tray 12 is inserted into the main body 10, to close the entrance 11 of the main body 10. Consequently, the present embodiment has a structure that prevents the disc from being ejected from the main body 10 during the operation of the optical recording and playback apparatus.

Furthermore, the opening and closing operation of the safety door is performed by the loading unit 30. Consequently, an additional drive motor to open and close the safety door 50 is not necessary, and therefore, the structure of the optical recording and playback apparatus is simplified.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An optical recording and playback apparatus comprising:
a main body having an entrance;
a deck mounted inside the main body and having a spindle motor and an optical pickup unit;
a tray to be inserted into or ejected from the main body through the entrance;
a loading unit to insert or eject the tray into or from the main body;
a safety door mounted at the entrance; and
a door opening and closing unit to move forward and backward according to an operation of the loading unit, to open and close the safety door.

2. The apparatus according to claim 1, wherein:
the tray comprises a first rack gear extending a predetermined length in a main direction in which the tray is inserted or ejected; and
the loading unit comprises a loading motor, a pinion gear engaged with the first rack gear to be rotated by the loading motor, a first cam having a second rack gear engaged with the pinion gear, the first cam being moved forward and backward according to an operation of the pinion gear to raise and lower the deck.

3. The apparatus according to claim 2, wherein the safety door is mounted at the entrance of the main body such that the safety door is moved upward and downward.

4. The apparatus according to claim 3, wherein the door opening and closing unit comprises:
a second cam disposed behind the safety door such that the second cam is moved forward and downward in a lateral direction, the second cam having at least one inclined slot, by which the door opening and closing unit is coupled with the safety door, and the safety door has at least one guide protrusion extending therefrom such that the at least one guide protrusion is inserted into the at least one inclined slot; and
a connection member connected between the second cam and the first cam.

5. The apparatus according to claim 4, wherein the first cam, the second cam, and the connection member are integrally formed in a single body.

6. An optical recording and playback apparatus, comprising:
a main body having an entrance;
a deck movably mounted inside the main body and having at least one of a spindle motor and an optical pickup unit;
a tray to move through the entrance;
a safety door movably mounted at the entrance; and
a loading unit to move the deck, the tray, and the safety door.

7. The apparatus according to claim 6, wherein the loading unit comprises a loading motor to move the deck, the tray, and the safety door.

8. The apparatus according to claim 6, wherein the loading motor is disposed between the entrance and the deck.

9. The apparatus according to claim 6, wherein the loading unit sequentially moves the tray, the safety door, and the deck in order.

10. The apparatus according to claim 6, wherein the loading unit sequentially moves the deck, the safety door, and the tray in order.

11. The apparatus according to claim 6, wherein:
the deck moves between a non-operation position and an operation position;
the tray moves between a loading position and an unloading position; and
the safety door moves between a closing position and an open position to open and close the entrance, respectively.

12. The apparatus according to claim 6, wherein the tray comprises a cam guide groove formed thereon such that the safety door is closed and open after the tray is moved inside the main body and before the tray is exposed outside the main body through the entrance.

13. The apparatus according to claim 6, further comprising:
a door opening and closing unit to move the safety door to an open position and a closing position to open and close the entrance according to a movement of the loading unit.

14. The apparatus according to claim 13, wherein the door opening and closing unit comprises a first cam to move the deck and a second cam to move the safety door, according to the movement of the loading unit.

15. The apparatus according to claim 14, wherein the first cam and the second cam are formed in a single monolithic body.

16. The apparatus according to claim 14, wherein:
the first cam and the second cam comprise one or more first and second inclined slots, respectively;
the deck comprises a deck protrusion to be inserted into the first slot of the first cam to be moved; and
the safety door comprises a door protrusion to be inserted into the second slot of the second cam to be moved.

17. The apparatus according to claim 14, wherein:
the tray comprises a cam guide groove formed thereon; and
a cam guide protrusion formed on one of the first cam and the second cam to contact the cam guide groove to control the first cam and the second cam according to a movement of the tray.

18. The apparatus according to claim 13, wherein:
the loading unit comprises a loading motor, and a gear unit receiving a rotational force of the loading unit;
the tray comprises a first rack gear unit to engage the gear unit; and
the door opening and closing unit comprises a second rack gear unit to engage the gear unit.

19. The apparatus according to claim 13, wherein the loading unit controls the tray to move in a main direction, the door opening and closing unit in a lateral direction, and the deck in an operation direction.

20. The apparatus according to claim 19, wherein the main direction, the lateral direction, and the operation direction are perpendicular to one another.

21. The apparatus according to claim 19, wherein the door opening and closing unit comprises:
a first cam disposed between the loading unit and the deck to move the deck; and
a second cam disposed between the loading unit and the safety door to move the safety door.

22. The apparatus according to claim 21, wherein the door opening and closing unit comprises a connection member to connect the first cam and the second cam.

23. The apparatus according to claim 13, wherein the tray comprises a cam guide groove to guide the door opening and closing unit to be engaged with the loading unit.

24. The apparatus according to claim 22, wherein the cam guide groove comprises:
a first groove to control the door opening and closing unit not to move;
a second groove to control the door opening and closing unit to contact the loading unit; and
a third groove to control the door opening and closing unit to close the entrance.

25. The apparatus according to claim 24, wherein:
the third groove controls the door opening and closing unit to move the safety door to an open position to open the entrance;
the second groove controls the door opening and closing unit to be disengaged from the loading unit; and
the first groove controls the door opening and closing unit to maintain the open position of the safety door.

26. An inserting and removing disc system usable with an optical recording and playback apparatus, comprising:
a loading unit to insert or eject a disc into or from the optical recording and playback apparatus through an entrance;
a deck to move the inserted disc between a first level at which the disc is inserted in optical recording and playback apparatus to a second level maintained during an operation of the optical recording and playback apparatus; and
a safety door unit to open and close the entrance according to an operation of the loading unit.

27. An optical recording and playback apparatus, comprising:
a main body having an entrance;
a loading unit to insert or eject a recording medium into or from the main body through the entrance;
a door opening and closing unit to move forward and backward according to an operation of the loading unit, to open and close the entrance; and
a disc securing mechanism to raise the recording medium at a level above the entrance level coupled to the door opening and closing unit closing the entrance.
